(19) United States
(12) Patent Application Publication
(10) Pub. No.: US 2011/0001683 A1
(43) Pub. Date: Jan. 6, 2011

(54) Antenna Array

(75) Inventors: Cheng-Hsuan Hsu, Taipei County (TW); Tsung-Wen Chiu, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/556,383

(22) Filed: Sep. 9, 2009

(30) Foreign Application Priority Data
Jul. 3, 2009 (TW) 098122558

(51) Int. Cl. H01Q 1/36; H01Q 21/00

(52) U.S. Cl. 343/893; 343/700 MS

(57) ABSTRACT

An antenna array comprises a plurality of radiation conductors, a first transmission network and a second transmission network. The radiation conductors are arranged symmetrically. Each radiation conductor has a first lateral and a second lateral. The first laterals are extended to delineate a first transmission network area. The second laterals are extended to delineate a second transmission network area. The first transmission network is arranged in the first transmission network area and has a first feeder point. The feed arms of the first transmission network are connected to the first laterals of the radiation conductors. The second transmission network is arranged in the second transmission network area and has a second feeder point. The feed arms of the second transmission network are connected to the second laterals of the radiation conductors.

### BACKGROUND OF THE INVENTION

1. Field of the Invention

The present invention relates to an antenna array, particularly to a dual-feeder point dual-polarized antenna array.

2. Description of the Related Art

An antenna array contains a plurality of antennae sequentially arranged according to a special rule. It is hard to control the radiation pattern of a single antenna and hard to attain sufficient gain therefrom. Further, the important parameters of a single antenna are less likely to satisfy a high-standard application. Therefore, some products needing high transmission quality have to adopt antenna arrays. In an antenna array, the component antenna units are arranged according to a special rule and have a special signal feeding method to attain the required effect. The greater the number of antenna units of an antenna array, the higher the gain, and the larger the size.

FIG. 1 is a perspective view of a “Dual Polarized Microstrip Patch Antenna Array for PCS Base Stations” disclosed in a U.S. Pat. No. 5,923,296, wherein a set of copper patches 3 and a set of copper patches 5 are alternately arranged on a printed circuit board 1 to form two antenna arrays polarized vertically to each other. However, the volume of such a design is several times larger than that of the ordinary antenna array. Besides, the two antenna structures are asymmetric. Thus, the radiation patterns thereof have a great difference, and interference is likely to occur therebetween.

### SUMMARY OF THE INVENTION

One objective of the present invention is to provide an antenna array, wherein first laterals and second laterals of radiation conductors are extended to respectively delineate different transmission network areas, and wherein the transmission network areas do not overlap, and wherein the feeding junctions of the radiation conductors are arranged at appropriate positions to make two corresponding radiation conductors have a phase difference of 180 degrees, whereby the cross polarization of the antenna array is reduced and the gain of the antenna array is increased.

Another objective of the present invention is to is to provide an antenna array, wherein a first transmission network and a second transmission network are respectively arranged in different transmission network areas, whereby is effectively reduced the signal interference between the transmission networks, and whereby is simplified the transmission networks, shortened the paths of the transmission networks, and increased the transmission efficiency of the radiation signals.

To achieve the abovementioned objectives, the present invention proposes an antenna array, which comprises a plurality of radiation conductors, a first transmission network and a second transmission network. The radiation conductors are arranged symmetrically. Each radiation conductor has a first lateral and a second lateral. The first laterals of the radiation conductors are extended to delineate a first transmission network area. The second laterals of the radiation conductors are extended to delineate a second transmission network area. The first transmission network is arranged in the first transmission network area and has a first feeder point. The feed arms of the first transmission network are connected to the first laterals of the radiation conductors. The second transmission network is arranged in the second transmission network area and has a second feeder point. The feed arms of the second transmission network are connected to the second laterals of the radiation conductors.

The feed arms of the first transmission network and the feed arms of the second transmission network are respectively connected to the first laterals and the second laterals of the radiation conductors, whereby the symmetrically arranged radiation conductors can generate two sets of signals vertical to each other. The first laterals and second laterals of the radiation conductors are extended to respectively delineate different transmission network areas. The feeding junction of each radiation conductor is arranged at an appropriate position, whereby the two corresponding radiation conductors have a phase difference of 180 degrees. As the radiation conductors are symmetrically arranged, the baseband-mode currents excited by the radiation conductors have opposite directions. After the phase-difference modulation, the baseband-mode radiation signals of two symmetric radiation conductors have the same direction. Thus, the gain of the antenna is multiplied synergistically. For the cross-polarization currents, which are vertical to the baseband mode currents, the two symmetric radiation conductors excite identical-direction currents. After the phase-difference modulation, the two symmetric radiation conductors inhibit the radiation signals mutually. Thus, cross-polarization is reduced, and the antenna gain is increased.

As the first transmission network and the second network are respectively arranged in different transmission network areas, the antenna array of the present invention is exempted from the signal interference between the transmission networks. Thus, the transmission efficiency of radiation signals is increased. Further, the present invention simplifies transmission networks and shortens the paths of the transmission networks. Therefore, the volume of the antenna array of the present invention is greatly reduced.

Below, the embodiments are described in detail to make the technical contents of the present invention easily understood.

### BRIEF DESCRIPTION OF THE DRAWINGS

FIG. 1 is a perspective view schematically showing a “Dual Polarized Microstrip Patch Antenna Array for PCS Base Stations” disclosed in a U.S. Pat. No. 5,923,296;

FIG. 2 is a top view schematically showing a front side an antenna array according to a first embodiment of the present invention;

FIG. 3 is a top view schematically showing a rear side of an antenna array according to the first embodiment of the present invention;

FIG. 4 is a top view schematically showing the transmission networks and the transmission network areas according to the first embodiment of the present invention;

FIG. 5 is a side view schematically showing an antenna array according to the first embodiment of the present invention;

FIG. 6 is a diagram showing the measurement result of the return loss of the first transmission network according to the first embodiment of the present invention;

FIG. 7 is a diagram showing the measurement result of the return loss of the second transmission network according to the first embodiment of the present invention;

FIG. 8 is a diagram showing the measurement result of the radiation pattern of the first transmission network according to the first embodiment of the present invention;

FIG. 9 is a diagram showing the measurement result of the radiation pattern of the second transmission network according to the first embodiment of the present invention;

FIG. 10 is a top view schematically showing a front side of an antenna array according to a second embodiment of the present invention; and

FIG. 11 is a perspective view schematically showing that an antenna array according to the second embodiment of the present invention is applied to a wireless transmission device.

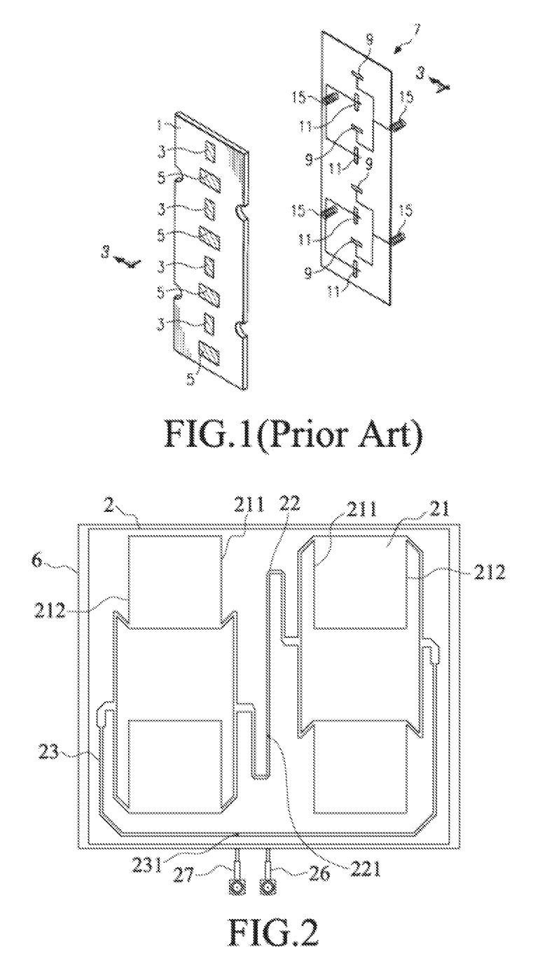

### DETAILED DESCRIPTION OF THE INVENTION

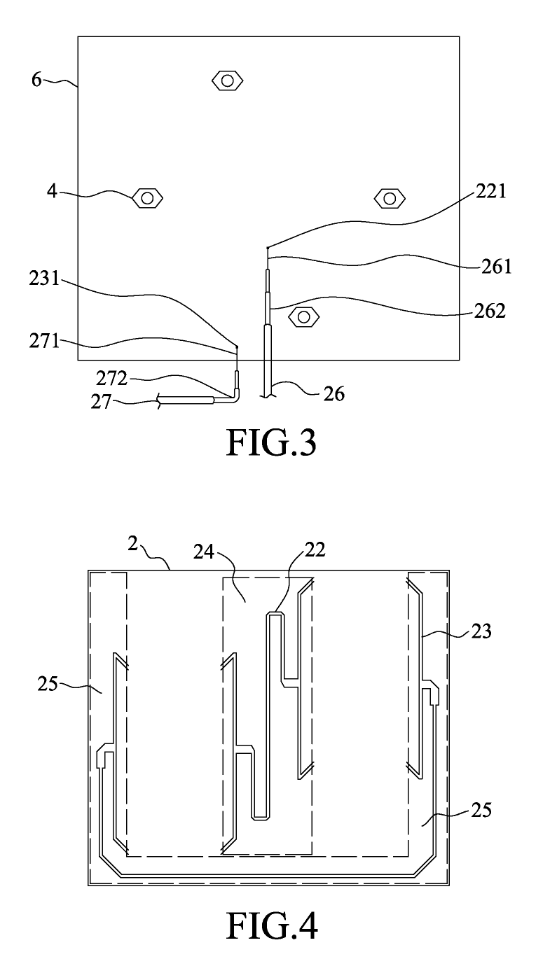

FIG. 2 and FIG. 3 are respectively a top view and a rear view of an antenna array according to a first embodiment of the present invention. As shown in FIG. 2 the antenna array of the present invention comprises a plurality of radiation conductors 21, a first transmission network 22 and a second transmission network 23. Each radiation conductor 21 has a first lateral 211 and a second lateral 212 opposite to the first lateral 211. Referring to FIG. 4, the first laterals 211 of the radiation conductors 21 are extended to delineate a first transmission network area 24. The second laterals 212 of the radiation conductors 21 are extended to delineate a second transmission network area 25. The first transmission network area 24 and the second transmission network area 25 do not overlap.

Referring to FIGS. 2, 3, and 4, the radiation conductors 21 are arranged on a substrate 2 to form a symmetric array. The substrate 2 is assembled to a metal carrier board 6 with non-metallic support pillars 4. The metal carrier board 6 functions as the grounding plane of the antenna system. The first transmission network 22 is arranged in the first transmission network area 24 and has a first feeder point 221. The first laterals 211 of the radiation conductors 21 are connected to four feed arms of the first transmission network 22. The radiation conductor 21 and the feed arm of the first transmission network 22 contain an included angle of 30-60 degrees. The antenna array of the present invention further comprises a first feeder cable 26. The first feeder cable 26 includes a first central wire 261 connected to the first feeder point 221 and a first external wire 262 connected to the grounding plane of the antenna system.

The second transmission network 23 is arranged in the second transmission network area 25 and has a second feeder point 231. The second laterals 212 of the radiation conductors 21 are connected to four feed arms of the second transmission network 23. The radiation conductor 21 and the feed arm of the second transmission network 23 contain an included angle of 30-60 degrees. The antenna array of the present invention further comprises a second feeder cable 27. The second feeder cable 27 includes a second central wire 271 connected to the second feeder point 231 and a second external wire 272 connected to the grounding plane of the antenna system.

In the first embodiment, the substrate 2 is a rectangle having a length of about 180 mm and a width of about 150 mm. The metal carrier board 6 is a rectangle giving a length of 200 mm and a width of 160 mm. The support pillar 4 is made of a non-metallic material and has a cylindrical shape with a diameter of about 3 mm and a height of about 6 mm. The radiation conductor 21 is a square having a length of about 45 mm. The path of the first transmission network 22 has a total length of about 410 mm. The path of the second transmission network 23 has a total length of about 550 mm.

FIG. 4 is a top view of the transmission networks and the transmission network areas according to the first embodiment of the present invention. The first transmission network 22 and the second transmission network 23 are respectively arranged in the first transmission network area 24 and the second transmission network area 25 without overlap. Therefore, the present invention is exempted from signal interference when signals are transmitted in the transmission networks. Further, the present invention has a simpler structure than the conventional technology. Thus, the volume of the antenna array is greatly reduced.

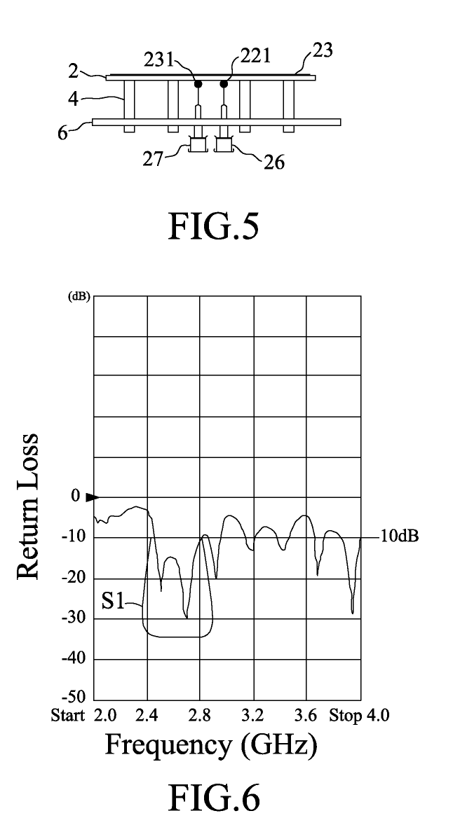

FIG. 5 is a side view of an antenna array according to the first embodiment of the present invention. The radiation conductors 21 are installed on the substrate 2 firstly. Then, the substrate 2 is assembled to the metal carrier board 6 with the non-metallic support pillars 4. The metal carrier board 6 is the grounding plane of the antenna system. The central wires of the first and second feeder cables 26 and 27 are respectively connected to the first feeder point 221 and the second feeder point 231. The external wires of the first and second feeder cables 26 and 27 are connected to the grounding plane of the antenna system.

FIG. 6 is a diagram schematically showing the measurement result of the return loss of the first transmission network according to the first embodiment of the present invention, wherein the horizontal axis denotes the frequency and the vertical axis denotes dB. When an operation frequency band S1 of the first transmission network is defined to be the frequency range having a return loss greater than 10 dB, the operation frequency band S1 is between 2.4 and 2.7 GHz, which covers the frequency band of the Wimax system.

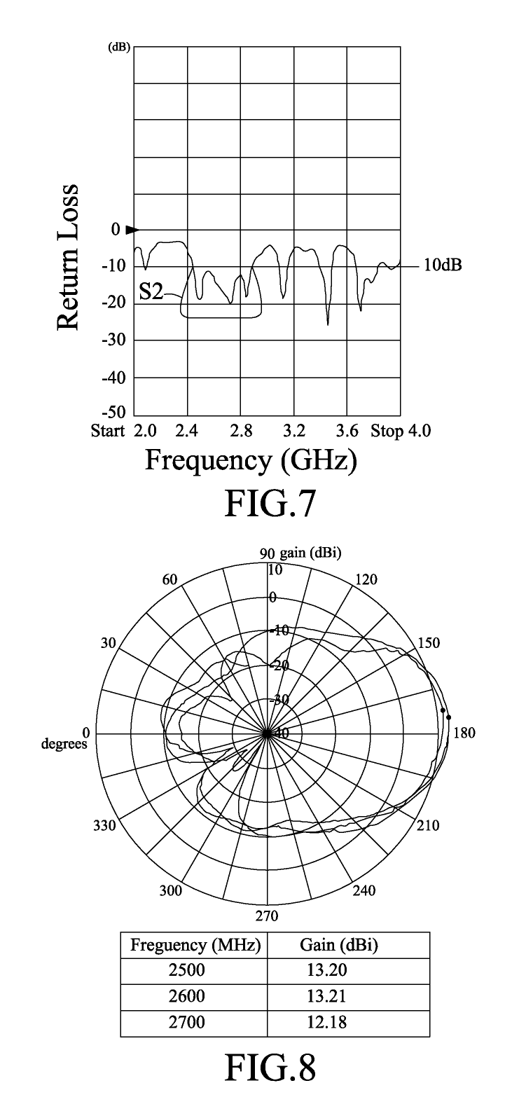

FIG. 7 is a diagram schematically showing the measurement result of the return loss of the second transmission network according to the first embodiment of the present invention, wherein the horizontal axis denotes the frequency and the vertical axis denotes dB. When an operation frequency band S2 of the second transmission network is defined to be the frequency range having a return loss greater than 10 dB, the operation frequency band S2 is between 2.4 and 2.8 GHz, which also covers the frequency band of the Wimax system. FIG. 6 and FIG. 7 show that the operation frequency bands of the antenna system of the present invention have met the requirement of the antenna design.

FIG. 8 is a diagram schematically showing the measurement result of the radiation pattern of the first transmission network according to the first embodiment of the present invention, wherein the central frequency of the radiation pattern of the antenna system ranges from 2500 to 2700 MHz. FIG. 8 shows that the maximum peak gains are all over 12.18 dBi.

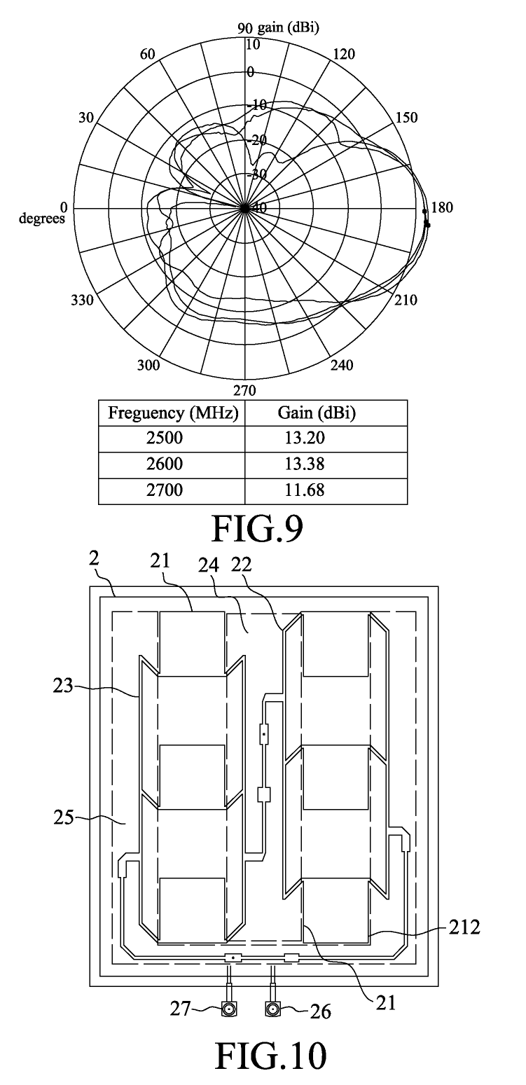

FIG. 9 is a diagram schematically showing the measurement result of the radiation pattern of the second transmission network according to the first embodiment of the present invention, wherein the central frequency of the radiation pattern of the antenna system ranges from 2500 to 2700 MHz. FIG. 9 shows that the maximum peak gains are all over 11.68 dBi. FIG. 8 and FIG. 9 show that the maximum peak gains of the radiation pattern of the present invention is obviously increased.

Therefore, the present invention can reduce the interference on the radiation pattern and achieve a higher gain.

FIG. 10 is a top view of an antenna array according to a second embodiment of the present invention. The second embodiment is basically similar to the first embodiment except the first embodiment has a 4×4 array of radiation conductors 21 and the second embodiment has a 6×6 array of radiation conductors 21. The configuration of the first transmission network 22 and the second transmission network 23 of the second embodiment is the same as that of the first embodiment. The first transmission network area 24 and the second transmission network 25 do not overlap in the second embodiment either. It should be mentioned herein that no matter what radiation conductor array an antenna system adopts, any person skilled in the art can easily design non-overlap transmission networks to prevent the transmission networks from mutual interference according to the spirit of the present invention, and that all the modifications and variations according to the spirit of the present invention should be also included within the scope of the present invention.

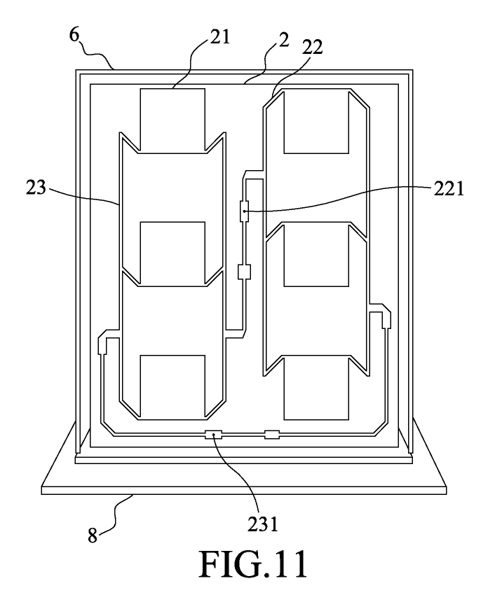

FIG. 11 is a perspective view schematically showing an antenna array according to the second embodiment of the present invention is applied to a wireless transmission device. When the antenna array of the present invention is integrated with a wireless transmission device, high-frequency signals are fed into the antenna system via two feeder cables. Then, the high-frequency signals are transmitted to all the radiation conductors 21 via the first feeder point 221 and the first transmission network 22, and the second feeder point 231 and the second transmission network 23. Thereby, wireless signals are transmitted or received.

The present invention possesses utility, novelty and non-obviousness. Therefore, the present invention meets the conditions for a patent. It should be noted herein that the embodiments described above are only to exemplify the present invention but not to limit the scope of the present invention. Any equivalent modification or variation according to the spirit of the present invention is to be also included within the scope of the present invention.

What is claimed is:

1. An antenna array comprising
a plurality of radiation conductors symmetrically arranged, each having a first lateral and a second lateral, wherein said first laterals of said radiation conductors are extended to delineate a first transmission network area, and said second laterals of said radiation conductors are extended to delineate a second transmission network area;
a first transmission network arranged in said first transmission network area and having a first feeder point, wherein feed arms of said first transmission network are connected to said first laterals of said radiation conductors; and
a second transmission network arranged in said second transmission network area and having a second feeder point, wherein feed arms of said second transmission network are connected to said second laterals of said radiation conductors.

2. The antenna array according to claim 1 further comprising a first feeder cable, which includes
a first central wire connected to said first feeder point; and
a first external wire connected to a grounding plane of said antenna array.

3. The antenna array according to claim 1 further comprising a second feeder cable, which includes
a second central wire connected to said second feeder point; and
a second external wire connected to a grounding plane of said antenna array.

4. The antenna array according to claim 1, wherein an included angle is contained by each said feed arm of said first transmission network and said radiation conductor connected to said feed arm; said included angle is between 30 and 60 degrees.

5. The antenna array according to claim 1, wherein an included angle is contained by each said feed arm of said second transmission network and said radiation conductor connected to said feed arm; said included angle is between 30 and 60 degrees.

6. The antenna array according to claim 1, wherein said first transmission network and said second transmission network do not overlap.
